(19) United States
(12) Patent Application Publication
(10) Pub. No.: US 2026/0162399 A1
(43) Pub. Date: Jun. 11, 2026

(54) METHOD FOR DETECTING LINE STRUCTURES IN IMAGE DATA

(71) Applicant: Robert Bosch GmbH, Stuttgart (DE)

(72) Inventors: Azhar Sultan, Tunbridge Wells (GB); Joel Janai, Leonberg (DE); Tamas Kapelner, Hildesheim (DE); Thomas Wenzel, Hamburg (DE)

(21) Appl. No.: 19/127,350

(22) PCT Filed: Dec. 4, 2023
(86) PCT No.: PCT/EP2023/084107

§ 371 Date: May 5, 2025

(30) Foreign Application Priority Data
Jan. 25, 2023 (DE) 10 2023 200 571.9

(51) Int. Cl. G06V 10/44; G06V 10/26; G06V 10/82

(52) U.S. Cl. CPC G06V 10/454; G06V 10/26; G06V 10/82

(57) ABSTRACT

The invention relates to a method for detecting line structures (14) in image data and determining their progression. The method comprises the steps of capturing (30) image data by means of an image sensor, dividing (32) the entire image data into a plurality of cells (18) and assigning at least one predefined and oriented line (22) of fixed length to each cell (18), and dividing (34) the at least one line (22) into a predetermined number of line segments (38). The method additionally comprises the steps of calculating (42a) a probability value for the existence of a line structure (14) for the at least one line (22) of each cell (18), calculating (42b) displacement values (dₙ) of start and end points (Aₙ, Eₙ) of the line segments (38) for a potential line structure (14), discarding (50) all lines (22) that are below a predefined probability threshold value, inputting (54) the probability values and the displacement values (dₙ) of the other lines (22) in a calculation function and outputting lines (22) that are most similar to the line structure (14), and determining (58) at least one partial progression of the line structure (14) from the remaining line (22) and the associated displacement values (dₙ), wherein all partial progressions specify an overall progression of the line structure (14).

### FIELD

The present invention relates to a method for detecting line structures in image data and determining their progression. Furthermore, the present invention also relates to a method for training a convolutional neural network to ascertain a line structure in image data and its progression.

### BACKGROUND INFORMATION

In the course of the increasing automation of vehicle functions, the detection of road markings and line-like structures in image data is becoming more and more important. It is important that various road markings can be detected correctly and quickly by the vehicle.

German Patent Application No. DE 10 2004 057 188 A1 describes a device for assisting the driving of a vehicle. The front scenery of a vehicle is displayed as an image by a CCD camera. The number of pixels in each horizontal line required to drive the vehicle is stored and it is determined whether the vehicle can drive past a parked vehicle based on a ratio of the number of pixels of the road where no vehicle is parked in the image to the number of pixels of each horizontal line based on the width of the vehicle.

European Patent Application No. EP 3 410 398 A1 describes a system for detecting road information that is able to determine the positions of lane markings on the other side of a lane after a lane change. The system comprises a means for detecting a front lane marking, a means for detecting a side lane marking and a means for estimating the front lane markings located on the other side of the lane after a lane change.

### SUMMARY

An object of the present invention is to provide a method with which line structures in image data may be detected and their progression determined, and with which line sections of limited length may also be detected in an improved manner.

The object may be achieved by a method for detecting line structures in image data and determining their progression, having certain features of the present invention. The present invention further provides a method for training a convolutional neural network. Preferred example embodiments of the present invention are disclosed herein.

The present invention provides a method for detecting line structures in image data and determining their progression. Line structures are understood to be the edges of three-dimensional bodies or marking lines such as road markings. Image data refers to both 2D and 3D images. According to an example embodiment of the present invention, the method comprises the steps of capturing image data by means of an image sensor, and dividing the entire image data into a plurality of cells and assigning at least one predefined and oriented line of fixed length to each cell. The image data are captured by the image sensor, which is advantageously a camera, lidar or radar sensor. According to the present invention, a line is not exclusively understood as a straight line. Accordingly, the term line also includes curved lines or curves.

In order to be able to detect line structures in all spatial directions, the cells are advantageously assigned a large number of differently oriented lines of fixed length. However, in order to detect only line structures of a certain orientation, it is advantageous to use only one line that exhibits the direction to be detected. By specifying lines of a fixed length, it is possible to detect line segments of a line structure. A line segment of the line structure may thus be mapped via each line. Accordingly, it is possible to detect a dashed lane line, for example, such that solid lane lines may be distinguished from dashed lane lines. The position of the dashes in the dashed line may also be detected. This improves the detection and differentiation of different line structures.

According to an example embodiment of the present invention, in further method steps, the at least one line is divided into a predetermined number of line segments, a probability value for the presence of a line structure is calculated for the at least one line of each cell, displacement values of start and end points of the line segments to a potential line structure are calculated, and all lines that are below a predefined probability threshold value are discarded. A line segment is defined as a section of the line of a fixed length. The line segments may all have the same or different lengths. Each line segment has a start point and an end point that coincide with the start and end points of neighboring line segments.

A probability value is a value that indicates whether a line structure is generally present. The different lines may thus be weighted via the probability value, such that a criterion is available according to which a decision may be made as to which line should be used to represent the line structure. By specifying a probability threshold, lines with a low probability value may be rejected in advance. This may significantly reduce the calculation effort in the further process.

In addition, according to an example embodiment of the present invention, the probability values and the displacement values of the remaining lines are entered into a calculation function and lines which are most similar to the line structure are output, and at least one partial progression of the line structures is determined from the remaining lines and the associated displacement values, wherein partial progressions indicate an overall progression of the line structures. The calculation function is, for example, an algorithm that uses the probability values and the displacement values to select the line that most closely corresponds to the line structure. These selected lines are the best starting point from which to arrive at the actual progression of the line structure. By applying the displacement values to the lines, the true progression of the line structure is obtained. Since each line only indicates a partial progression of an overall progression of the line structure, it is also possible to display interruptions in the line structure, for example to detect a dashed lane marking and the exact position of the partial lines.

In a preferred example embodiment of the present invention, the steps are carried out by means of a trained convolutional neural network. A trained convolutional neural network is used to create a generalized model based on training examples. After training, such a network may be used to quickly and easily detect the actual progression of a line structure. This may be carried out permanently, for example during a journey, to detect lane markings.

In a further preferred example embodiment of the present invention, a length adjustment value is calculated in addition to the probability values and the displacement values, via which the length of the line of fixed length is adjusted in accordance with the line structures. A length adjustment value is a factor by which each line segment must be lengthened or shortened in order to achieve the length of the line structure. This makes it possible to adjust each line according to the length of the line structure. Line segments of a dashed line may thus be displayed with the correct length via the method.

Preferably, the lines of fixed length are indicated in the form of a parameter function. By indicating a line in a parameter function, it may be described more easily. In addition, it is possible to generate a large number of lines by changing a few parameters of the function, which may nevertheless be described by the same parameter function. An execution of the method is simplified and accelerated as a result.

In an advantageous development of the present invention, at least one non-maximum suppression function is used for the calculation functions. In the case of a non-maximum suppression function, the highest probability value is assumed in particular. Of the remaining lines, only the line with the highest probability value is retained from the lines that are grouped according to a similarity function in the non-maximum suppression. This makes it possible to detect a plurality of line structures in one image.

The present invention also provides a method for training a convolutional neural network to ascertain a line structure and its progression. According to an example embodiment of the present invention, in a first step, training data comprising at least sensor data with at least one line structure with a known progression, for which probability values and displacement values are specified, are entered. The probability values and the displacement values ascertained by the convolutional neural network according to the method according to the present invention are compared with the predetermined probability values and displacement values. Deviations are evaluated using a cost function. Parameters that characterize the behavior of the model are changed with the aim that further processing of training data by the convolutional neural network is expected to improve the evaluation by the cost functions, and releasing these parameters if an ascertained accuracy value reaches a predetermined value.

Advantageously, according to an example embodiment of the present invention, the convolutional neural network is trained to estimate a length adjustment value of the fixed-length line with respect to the line structure. By additionally training the length adjustment values, these may be determined more precisely by the method. The advantages described above are achieved accordingly.

The object of the present invention may additionally be achieved by a control device which is configured to carry out the method according to the present invention.

The method of the present invention described above may, for example, be computer-implemented and thus embodied in software. The present invention therefore also relates to a computer program comprising machine-readable instructions which, when executed on one or more computers, cause the computer or computers to perform the described method of the present invention.

The present invention also relates to a machine-readable data carrier and/or a download product with the computer program. A download product is a digital product that may be transferred via a data network, i.e., downloaded by a user of the data network, which may be offered for immediate download in an online store, for example.

Such a computer program may be operated on one or more computers, which are arranged in a cloud, for example. The advantages mentioned for the method of the present invention are achieved via such a computer operated in the cloud.

Exemplary embodiments of the present invention are illustrated in the figures and explained in more detail in the following description.

### BRIEF DESCRIPTION OF THE DRAWINGS

FIG. 1 shows an image of a roadway captured via a camera,

FIG. 2 shows a diagram of a method for detecting line structures and determining their progression, according to an example embodiment of the present invention.

FIG. 3 shows an illustration of a predefined line divided into line segments and a line structure before a length adjustment, according to an example embodiment of the present invention.

FIG. 4 shows an illustration of a predefined line divided into line segments and a line structure after a length adjustment.

FIG. 5 shows a diagram of a method for training a convolutional neural network according to an exemplary embodiment of the present invention.

### DETAILED DESCRIPTION OF EXAMPLE EMBODIMENTS

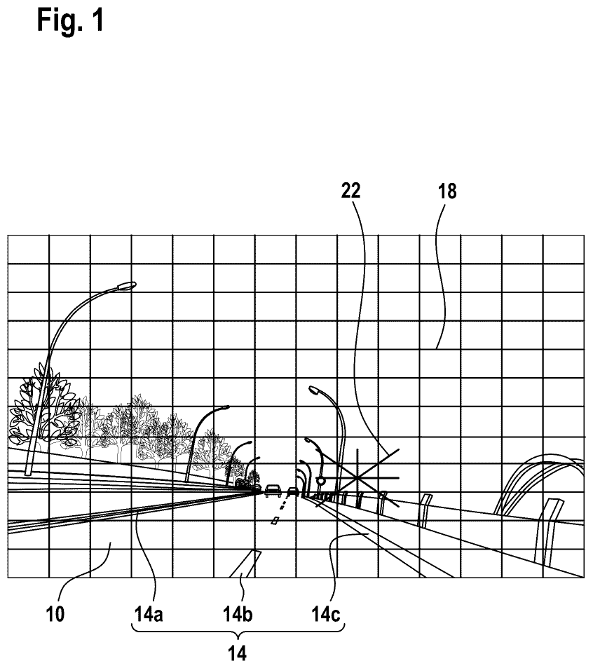

FIG. 1 shows an image of a roadway 10 captured via a camera in a motor vehicle. The image shows line structures 14, for example a solid lane marking 14a, a dashed lane marking 14b and a sidewalk edge 14c. For the method according to the present invention, the image was divided into a plurality of cells 18. A cell 18 shows that a plurality of differently oriented lines 22 of fixed length are assigned to it. Although this is only shown for one cell 18, all cells 18 exhibit these lines 22.

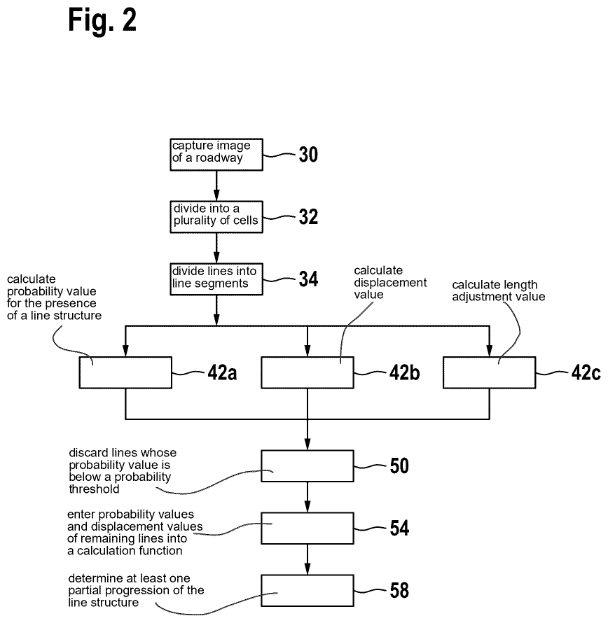

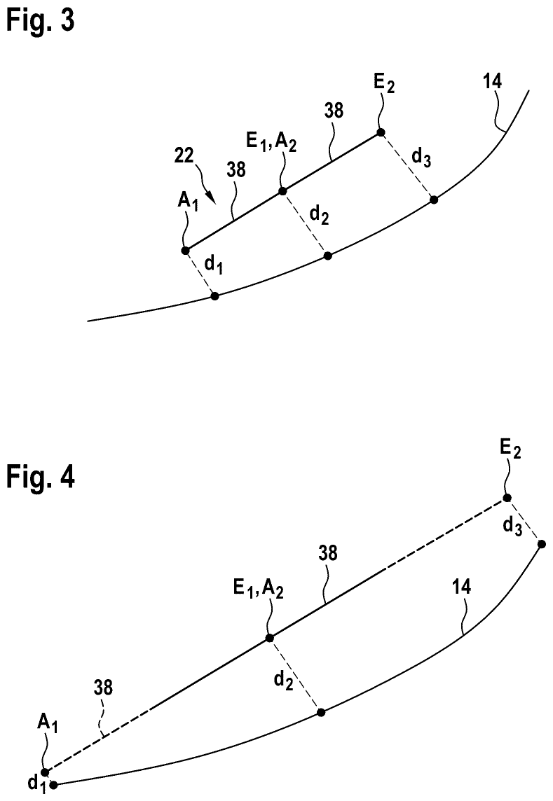

FIG. 2 shows a diagram of a method for detecting line structures 14 and determining their progression. In a first step 30 of the method, an image of a roadway 10 is captured. The image, or the image data, is then divided 32 into a plurality of cells 18, as shown in FIG. 1. Lines 22 are assigned to each cell 18, as shown in a cell 18 shown in FIG. 1. These lines 22 are oriented differently and have a fixed length. In a subsequent step 34, the lines 22 are divided into a predetermined number of line segments 38. FIG. 3 shows a line 22 which is divided into two line segments 38 of equal length.

In a next method step 42a, a probability value for the presence of a line structure 14 in the corresponding cell 18 is calculated for each line 22 of each cell 18. At the same time, as shown in FIG. 3, a displacement value dₙ to a potential line structure 14 is calculated 42b. The displacement value dₙ may be an orthogonal distance of the line 22 to the line structure 14, as shown in the exemplary embodiment. The displacement values dₙ are calculated from the start and end points Aₙ, Eₙ of the line segments 38. In addition to the displacement values dₙ and the probability values, a length adjustment value is calculated at the same time 42c. As shown in FIG. 4, the length of the line segments 38 is extended such that the line 22 corresponds to the length of the line structure 14. The displacement values dₙ of the new start and end points Aₙ, Eₙ are adjusted accordingly.

To reduce the computational effort, all lines 22 whose probability value is below a probability threshold are discarded in a subsequent step 50. The probability values and the displacement values dₙ of the remaining lines 22 are then entered into a calculation function 54. The calculation function calculates lines 22 which are most similar to the line structure 14. If there is no line structure 14 in the image, no line 22 would be output. Similarly, if several line structures 14 are present, a plurality of lines 22 could also be output. Subsequently, at least one partial progression of the line structure 14 is determined 58 from the remaining line 22 and the associated displacement values dₙ, wherein partial progressions indicate an overall progression of the line structure 14.

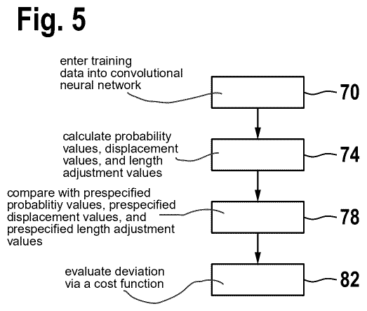

FIG. 5 shows a diagram of a method for training a convolutional neural network according to an exemplary embodiment of the present invention. The convolutional neural network is trained with this method such that this network may carry out the method shown in FIG. 2. In a first step 70, training data are entered into the convolutional neural network. The training data comprise at least image data with at least one line structure 14 with a known progression. These probability values and the displacement values dₙ for this line structure 14 are in this case prespecified.

According to the method shown in FIG. 2, the probability values, the displacement values dₙ and the length adjustment values are calculated in the next step 74. These are then compared with the prespecified probability values, the prespecified displacement values dₙ and the prespecified length adjustment values 78. A deviation from the prespecified values is calculated for each of these values. In a next step 82, this deviation is evaluated via a cost function. Subsequently, parameters that characterize the behavior of the model are changed with the aim that further processing of training data by the convolutional neural network is likely to improve the evaluation by the cost functions. This is carried out accordingly until an ascertained accuracy value for the ascertainment of the probability values, the displacement values dₙ and the length adjustment values reaches a predetermined value. Advantageously, this value is a limit value of a learning curve, after no further or significant improvement is achieved following further runs.

1-11. (canceled)

12. A method for detecting line structures in image data and determining a progression of the line structures, comprising the following steps:
acquiring image data using an image sensor;
dividing the entire image data into a plurality of cells and assigning at least one predefined and oriented line of fixed length to each of the cells;
dividing the at least one line into a predetermined number of line segments;
calculating a probability value for the presence of a line structure for the at least one line of each cell;
calculating displacement values of start and end points of the line segments to a potential line structure;
discarding all of the lines that are below a predefined probability threshold;
inputting the probability values and the displacement values of remaining lines of the lines into a calculation function and outputting lines which are most similar to the line structure; and
determining at least one partial progression of the line structure from the remaining line and the displacement values of the remaining line, wherein all partial progressions indicate an overall progression of the line structure.

13. The method according to claim 12, wherein the steps are carried using a trained convolutional neural network.

14. The method according to claim 12, wherein a length adjustment value is calculated, via which the line of fixed length is adapted in its length in accordance with the line structures.

15. The method according to claim 12, wherein the lines of fixed length are indicated in the form of a parameter function.

16. The method according to claim 12, wherein at least one non-maximum suppression function is used for the calculation function.

17. A method for training a convolutional neural network to ascertain a line structure in image data and its progression, comprising the following steps:
inputting training data, including at least image data with at least one line structure with a known progression, for which probability values and displacement values are predetermined;
comparing probability values and displacement values ascertained by the convolutional neural network with the predetermined probability values and displacement values;
evaluating deviations with a cost function; and
changing parameters that characterize a behavior of the model with an aim that with further processing of training data by the convolutional neural network, the evaluation by the cost functions is likely to be improved, and releasing the parameters when an ascertained accuracy value reaches a predetermined value.

18. The method according to claim 17, wherein the convolutional neural network ascertains the probability and displacement values by:
dividing the entire image data into a plurality of cells and assigning at least one predefined and oriented line of fixed length to each of the cells;
dividing the at least one line into a predetermined number of line segments;
calculating a probability value for the presence of a line structure for the at least one line of each cell;
calculating displacement values of start and end points of the line segments to a potential line structure;
discarding all of the lines that are below a predefined probability threshold;
inputting the probability values and the displacement values of remaining lines of the lines into a calculation function and outputting lines which are most similar to the line structure; and
determining at least one partial progression of the line structure from the remaining line and the displacement values of the remaining line, wherein all partial progressions indicate an overall progression of the line structure.

19. The method according to claim 18, wherein the convolutional neural network is trained to estimate a length adjustment value of the line of fixed length with respect to the line structure.

20. A control unit of a motor vehicle configured to detect line structures in image data and determining a progression of the line structures, the control unit configured to:
acquire image data using an image sensor;
divide the entire image data into a plurality of cells and assigning at least one predefined and oriented line of fixed length to each of the cells;
divide the at least one line into a predetermined number of line segments;
calculate a probability value for the presence of a line structure for the at least one line of each cell;
calculate displacement values of start and end points of the line segments to a potential line structure;
discard all of the lines that are below a predefined probability threshold;
inputting the probability values and the displacement values of remaining lines of the lines into a calculation function and outputting lines which are most similar to the line structure; and
determine at least one partial progression of the line structure from the remaining line and the displacement values of the remaining line, wherein all partial progressions indicate an overall progression of the line structure.

21. A non-transitory machine-readable data carrier on which is stored a computer program including machine-readable instructions for detecting line structures in image data and determining a progression of the line structures, the instructions, when executed by one or more computers, causing the one or more computers to perform the following steps:
acquiring image data using an image sensor;
dividing the entire image data into a plurality of cells and assigning at least one predefined and oriented line of fixed length to each of the cells;
dividing the at least one line into a predetermined number of line segments;
calculating a probability value for the presence of a line structure for the at least one line of each cell;
calculating displacement values of start and end points of the line segments to a potential line structure;
discarding all of the lines that are below a predefined probability threshold;
inputting the probability values and the displacement values of remaining lines of the lines into a calculation function and outputting lines which are most similar to the line structure; and
determining at least one partial progression of the line structure from the remaining line and the displacement values of the remaining line, wherein all partial progressions indicate an overall progression of the line structure.

22. A computer equipped with a machine-readable data carrier on which is stored a computer program including machine-readable instructions for detecting line structures in image data and determining a progression of the line structures, the instructions, when executed by the computer, causing the computer to perform the following steps:
acquiring image data using an image sensor;
dividing the entire image data into a plurality of cells and assigning at least one predefined and oriented line of fixed length to each of the cells;
dividing the at least one line into a predetermined number of line segments;
calculating a probability value for the presence of a line structure for the at least one line of each cell;
calculating displacement values of start and end points of the line segments to a potential line structure;
discarding all of the lines that are below a predefined probability threshold;
inputting the probability values and the displacement values of remaining lines of the lines into a calculation function and outputting lines which are most similar to the line structure; and
determining at least one partial progression of the line structure from the remaining line and the displacement values of the remaining line, wherein all partial progressions indicate an overall progression of the line structure.
